(19) United States
(12) Patent Application Publication
(10) Pub. No.: US 2008/0118651 A1
(43) Pub. Date: May 22, 2008

(54) Method for Producing a Permanent Protective Layer on Precious Metal Surfaces by Coating with Solutions Based on Polysilazane

(76) Inventors: Stefan Brand, Hirschberg-Leutershausen (DE); Andreas Dierdorf, Hofheim (DE); Hubert Liebe, Wiesbaden (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/883,153

(22) PCT Filed: Jan. 12, 2006
(86) PCT No.: PCT/EP06/00213

§ 371 Date: Jul. 25, 2007

(30) Foreign Application Priority Data
Jan. 26, 2005 (DE) 10 2005 003 627.9

(51) Int. Cl. B05D 1/36

(52) U.S. Cl. 427/409

(57) ABSTRACT

A method used to produce a permanent support layer on precious metal surfaces by coating solutions which are based on polysilazane. Said method is used to coat surfaces made of precious metal or precious metal alloys with a solution containing a polysilazane of formula (I), wherein n is measured in such a manner that the polysilazane has an average molecular weight from 150-150,000 g/mol, in addition to a solvent and a catalyst. The invention is characterized in that a silane based primer which contains sulphur and which is used to improve adherence, is applied to the object which is to be coated prior to the coating with the polysilazane solution. The invention also relates to coatings which are produced according to the inventive method.

The present invention relates to a method for producing a permanent protective coat on precious metal surfaces, in particular silver surfaces for the purpose of preventing tarnishing.

Articles composed of precious metal or articles coated with precious metal surfaces deposited for example by electroplating form a layer of sulfide and oxide in the air; depending on the duration of exposure, this layer forms yellowish, brownish to black, flecky coverings and is generally referred to as tarnishing. This tarnishing is additionally boosted by chemical influences, such as by skin contact (perspiration, body grease, etc.) or by contact with foods and drinks, for example. This applies in particular to silver and silver alloys, as used for silver jewelry and silver-plated articles such as cutlery, silverware, silver service items, and silver candlesticks. It also applies to other precious metals, such as gold, platinum and its alloys, as used primarily in the jewelry field.

The tarnishing on silver surfaces is prevented in accordance with the prior art by means of rhodanizing—that is, by electrodeposition of a layer of rhodium. A disadvantage of this technique is the change in the color of the article, the piece of silver jewelry for example. Rhodanizing makes silver and silver alloys grayish, and they lose their typical silver brightness.

A further method of preventing tarnishing is the coating of the article with a polymer dispersion. Polymer dispersions form a polymer film on the surface that protects silver from tarnishing. These polymer films, however, are not scratchproof and do not remain permanently on the surface of the article. Through use, the polymer film is effaced, and the article tarnishes. This problem is associated fundamentally with the inadequate adhesion of coatings to silver and other precious metal surfaces, and occurs in particular with surfaces which have a high (>95%) silver content (silver-plated articles, for example).

DE 103 20 180 A1 describes the use of polysilazanes as permanent tarnish protection for articles made of silver. That coating is extremely suitable for the coating of silver alloys such as, for example, articles made of 800 grade or 925 grade silver, as described in examples 1 to 5 therein.

In the case of the coating of surfaces having a higher silver content (>95%), however, adhesion problems occur, and so in this case the protection obtained is not permanent. On other precious metal surfaces, likewise, the method is of very limited suitability, since depending on metal and alloy the adhesion is inadequate. It is therefore an object of the present invention to provide a method which allows the production of a permanent protective coat on precious metals as well.

Surprisingly it has now been found that polysilazanes are suitable for a permanent protective coat to prevent the tarnishing of precious metal surfaces as well, especially silver surfaces, if beforehand a silane-based primer is applied that enhances the adhesion of the polysilazane coating.

The present invention therefore achieves the stated object and provides a method of coating surfaces of precious metal or precious metal alloys with a solution comprising a polysilazane of formula I (first polysilazane coat)

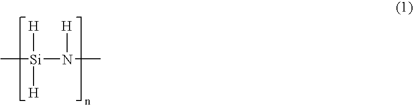

in which n is such that the polysilazane has a number-average molecular weight of 150 to 150 000 g/mol, and also a solvent and a catalyst, and, prior to coating with the polysilazane solution, a sulfur-containing, silane-based primer is applied to the article to be coated, for the purpose of promoting the adhesion.

By means of this priming it is possible to coat even precious metal surfaces on which, otherwise, sufficient adhesion of the polysilazane is not guaranteed, such as, for example, silver surfaces having a silver content of >95%, or gold surfaces. The primer comprises silanes which contain a thiol, disulfide function, providing for firm anchorage of the polysilazane on the silver surface.

By precious metals are meant in accordance with the invention the pure metals or alloys of precious metals having a precious metal content of at least 60%, preferably 70%, in particular >75%. A precious metal here is a metal whose standard potential ε₀ (in volts) according to the electrochemical voltage series with respect to the standard hydrogen electrode (0 volt) has a value of >0.3 volt. Examples of the metals in question include copper, silver, gold, platinum, palladium, rhodium, iridium, ruthenium, and osmium.

The silane-based primer used in accordance with the invention comprises at least one silane that possesses a sulfur-containing functional group.

Particularly suitable in this context are silanes of the formula 2 to 4 or mixtures of these silanes

HS—CH₂—CH₂—CH₂—SiR₃ (2)

R₃Si—CH₂—CH₂—CH₂—S—S—CH₂—CH₂—CH₂—SiR₃ (3)

R₃Si—CH₂—CH₂—CH₂—S—S—S—S—CH₂—CH₂—CH₂—SiR₃ (4)

where R is identical or different and R is an alkyl radical, in particular a methyl, ethyl, propyl or alkoxy radical, in particular a methoxy, ethoxy or propoxy radical. The primer is typically used in diluted form, i.e., as a solution in an organic solvent such as, for example, alcohol, ketone, ether or ester and also mixtures of these solvents. The solution may additionally include further constituents as well, such as water, acids or bases. The concentration of the silanes of the formula (2) to (4) in the primer solution is 0.1% to 50%, preferably 0.5% to 10%, more preferably 1% to 3%.

The preparation of suitable silane-based primer formulations is known to the skilled worker. Information on the composition and preparation of primer formulations can be found for example in the technical information entitled “Silane primers—examples of the formulation of silane primers for paints and coatings” from Degussa AG (under www.sivento.com).

The function of the silane primer is to create a firm bond between the polysilazane and the precious metal surface. The sulfur-containing functional groups of the silane primer possess a high affinity for precious metal surfaces and are able to enter into a permanent bond with them, while the silane groups possess a high affinity for the polysilazane and likewise enter into a permanent bond with it.

After the article has been treated with the primer solution, the excess primer is washed off with water or a solvent and then the residual solvent is evaporated. This can be done either at room temperature or in a drying cabinet at an elevated temperature, and the polysilazane coating applied. Depending on the polysilazane, solvent, and catalyst used, this coating is then dried at room temperature or in a drying cabinet.

Generally speaking, the proportion of polysilazane in the solvent is 1% to 50% by weight polysilazane, preferably 3% to 30% by weight, more preferably 5% to 20% by weight.

Solvents particularly suitable for the polysilazane are organic solvents which contain no water and also no reactive groups (such as hydroxyl groups or amine groups). The solvents in question are, for example, aliphatic or aromatic hydrocarbons, halogenated hydrocarbons, esters such as ethyl acetate or butyl acetate, ketones such as acetone or methyl ethyl ketone, ethers such as tetrahydrofuran or dibutyl ether, and also mono- and polyalkylene glycol dialkyl ethers (glymes) or mixtures of these solvents.

A further constituent of the polysilazane formulation may be additives, which modify, for example, the formulation viscosity, substrate wetting, film formation or flash-off characteristics, or inorganic nanoparticles such as, for example, SiO₂, TiO₂, ZnO, ZrO₂ or Al₂O₃.

The catalysts used may for example be organic amines, acids, or metals or metal salts, preferably metal carboxylates or acetylacetonates, or mixtures of these compounds. The catalyst preferably comprises at least one compound selected from the following group: N-heterocyclic compounds, mono-, di-, and trialkylamines, organic and inorganic acids, metal carboxylates of the general formula (RCOO)ₙM of saturated and unsaturated, aliphatic or alicyclic carboxylic acids with R=C₁-C₂₂ and metal ions M with the charge n, acetylacetonate complexes of metal ions, metal powders having a particle size of 20 to 500 nm, peroxides, metal chlorides, and organometallic compounds.

The catalyst is used preferably in amounts of 0.001% to 10%, in particular 0.01% to 6%, more preferably 0.1% to 3%, based on the weight of the polysilazane. Examples of amine catalysts are ammonia, methylamine, dimethylamine, trimethylamine, ethylamine, diethylamine, triethylamine, n-propylamine, isopropylamine, di-n-propylamine, diisopropylamine, tri-n-propylamine, n-butylamine, isobutylamine, di-n-butylamine, diisobutylamine, tri-n-butylamine, n-pentylamine, di-n-pentylamine, tri-n-pentylamine, dicyclohexylamine, aniline, 2,4-dimethylpyridine, 4,4-trimethylenebis-(1-methylpiperidine), 1,4-diazabicyclo[2,2,2]octane, N,N-dimethylpiperazine, cis-2,6-dimethylpiperazine, trans-2,5-dimethylpiperazine, 4,4-methylenebis(cyclohexylamine), stearylamine, 1,3-di-(4-piperidyl)propane, N,N-dimethylpropanolamine, N,N-dimethylhexanolamine, N,N-dimethyloctanolamine, N,N-diethylethanolamine, 1-piperidineethanol, and 4-piperidinol.

Examples of organic acids are acetic acid, propionic acid, butyric acid, valeric acid, and caproic acid.

Examples of metals and metal compounds as catalysts are palladium, palladium acetate, palladium acetylacetonate, palladium propionate, nickel, nickel acetylacetonate, silver, silver acetate, silver acetylacetonate, platinum, platinum acetylacetonate, ruthenium, ruthenium acetylacetonate, ruthenium carbonyls, gold, copper, copper acetylacetonate, aluminum acetylacetonate, and aluminum tris(ethyl acetoacetate).

Depending on the catalyst system used, the presence of moisture or of oxygen may play a part in the curing of the coating. For instance, through the choice of a suitable catalyst system, it is possible to achieve rapid curing at high or low atmospheric humidity or with a high or low oxygen content. The skilled worker is aware of these effects and will adjust the atmospheric conditions accordingly by means of suitable optimization methods.

A further possibility is to provide the surfaces coated with the above-described first polysilazane coat with a second coat of polysilazane, in order to produce a thicker coating. This thicker coat may contribute to stopping any interference patterns that occur. The second coat may comprise a polysilazane of the formula 1 or else substituted polysilazanes which instead of the hydrogen atoms on the silicon or on the oxygen carry one or two organic groups, such as methyl, ethyl, propyl, vinyl, phenyl or trialkoxysilyl-substituted alkyl groups, for example. Polysilazanes of this kind, and the preparation of these polysilazanes, are described for example in U.S. Pat. No. 6,329,487, U.S. Pat. No. 6,652,978 or U.S. Pat. No. 6,534,184. Those specifications are hereby incorporated by reference.

The invention further provides coatings for precious metal surfaces, especially silver surfaces, which are produced with the method of the invention.

Examples of surfaces of silver and silver alloys which can be coated in accordance with the invention are silver jewelry having a silver content of 75% to 99%, preferably having a silver content of 80% to 92.5% (800 grade silver and 925 grade “sterling” silver), such as, for example, polished silver jewelry, matt-finished silver jewelry, brushed silver jewelry, diamond-finished silver jewelry, with and without gemstones such as diamonds, precious stones, semiprecious stones, and glass.

Examples of silver-plated surfaces are products having a silver coating of 1 to 100 microns, preferably in a silver plated version with a silver coating of 18 microns' thickness or with a silver coating of 36 microns, i.e., 90 g of silver per 1000 g of product (80 grade silver) for silver-plated cutlery, for example.

### EXAMPLES

The examples which follow describe the production of a firmly adhering protective coat using the primer. The polysilazane solutions used are perhydropolysilazane solutions from Clariant Japan K.K. The solvent used is di-n-butyl ether (designation NL). The solution contains (0.75% by weight) palladium propionate, based on the perhydropolysilazane, as a catalyst.

### Inventive Example 1

### Coating of a Silver Sheet (99.9%) with Priming Beforehand Using a Sulfur-Containing Primer

A silver sheet having a silver content of 99.9% is cleaned or degreased by rinsing with isopropanol and is immersed for one hour in a primer solution whose composition is as follows (% by weight): 3-(trimethoxysilyl)-1-propanethiol 2%, isopropanol 88%, water 9.4%, glacial acetic acid 0.6%. After the silver sheet has been removed from the primer solution, excess primer solution is rinsed off with isopropanol and adhering isopropanol is evaporated off in a drying cabinet (130° C., 5 min). After it has cooled to room temperature, the silver sheet is immersed for 1 minute in a polysilazane solution (20% strength in dibutyl ether, contains palladium catalyst) and withdrawn slowly from the polysilazane solution. Excess drops of polysilazane solution are removed using a cloth. After dibutyl ether has evaporated off (10 min, room temperature), the polysilazane-coated silver sheet is cured in a drying cabinet (130° C., 3 h).

### Inventive Example 2

### Coating of a Silver Spoon (Silver-Plated) with Priming Beforehand Using a Sulfur-Containing Primer

A silver spoon (silver-plated, silver content of the silver coating >99%) is cleaned or degreased by rinsing with isopropanol and is immersed for one hour in a primer solution whose composition is as follows (% by weight): 3-(trimethoxysilyl)-1-propanethiol 2%, isopropanol 88%, water 9.4%, glacial acetic acid 0.6%. After the silver spoon has been removed from the primer solution, excess primer solution is rinsed off with isopropanol and adhering isopropanol is evaporated off in a drying cabinet (130° C., 5 min). After it has cooled to room temperature, the silver spoon is immersed for 1 minute in a polysilazane solution (20% strength in dibutyl ether, contains palladium catalyst) and withdrawn slowly from the polysilazane solution. Excess drops of polysilazane solution are removed using a cloth. After dibutyl ether has evaporated off (10 min, room temperature), the polysilazane-coated silver spoon is cured in a drying cabinet (130° C., 3 h).

### Comparative Example 1

### Coating of a Silver Sheet (99.9%) Without Priming

A silver sheet having a silver content of 99.9% is cleaned or degreased by rinsing with isopropanol. Adhering isopropanol is removed in a drying cabinet (130° C., 5 min). After it has cooled to room temperature, the silver sheet is immersed for 1 minute in a polysilazane solution (20% strength in dibutyl ether, contains palladium catalyst) and withdrawn slowly from the polysilazane solution. Excess drops of polysilazane solution are removed using a cloth. After dibutyl ether has evaporated off (10 min, room temperature), the polysilazane-coated silver sheet is cured in a drying cabinet (130° C., 3 h).

### Comparative Example 2

### Coating of a Silver Spoon (Silver-Plated) Without Priming

A silver spoon (silver-plated, silver content of the silver coating >99%) is cleaned or degreased by rinsing with isopropanol. Adhering isopropanol is removed in a drying cabinet (130° C., 5 min). After it has cooled to room temperature, the silver spoon is immersed for 1 minute in a polysilazane solution (20% strength in dibutyl ether, contains palladium catalyst) and withdrawn slowly from the polysilazane solution. Excess drops of polysilazane solution are removed using a cloth. After dibutyl ether has evaporated off (10 min, room temperature), the polysilazane-coated silver spoon is cured in a drying cabinet (130° C., 3 h).

### Comparative Example 3

### Coating of a Silver Sheet (99.9%) with Priming Beforehand with AMEO Solution

A silver sheet having a silver content of 99.9% is cleaned or degreased by rinsing with isopropanol and is immersed for 1 minute in an AMEO primer solution whose composition is as follows (% by weight): 3-(triethoxysilyl)-propylamine (AMEO) 1%, isopropanol 98.5%, water 0.5%. After the silver sheet has been removed from the primer solution, it is left at room temperature for 30 minutes, and the silver sheet is rinsed off with water and dried in a drying cabinet (130° C., 5 min). After it has cooled to room temperature, the silver sheet is immersed for 1 minute in a polysilazane solution (20% strength in dibutyl ether, contains palladium catalyst) and withdrawn slowly from the polysilazane solution. Excess drops of polysilazane solution are removed using a cloth. After dibutyl ether has evaporated off (10 min, room temperature), the polysilazane-coated silver sheet is cured in a drying cabinet (130° C., 3 h).

### Example 3

### Determining the Adhesion by Tesa Testing

The adhesion of the polysilazane coatings from inventive examples 1 and 2 and also from comparative examples 1 to 3 on silver is tested by applying and removing a tesa film strip to the polysilazane coating. The result obtained is as follows:

### Inventive examples 1 and 2: no detachment of the coating is observed very good adhesion of the coating to silver

### Comparative examples 1-3: marked delamination of the coating, in some cases complete detachment of the coating

### Example 4

### Determination of Resistance to Hydrogen Sulfide

The tarnish protection of the polysilazane-coated silver objects (silver sheet, silver-plated spoon) from inventive examples 1 and 2, in comparison to uncoated silver objects, was tested by storing the objects in a sample chamber, into which H₂S was metered. After six hours of storage, the following was observed:

| | |
|---|---|
| coated: | no discoloration at all apparent |
| uncoated: | silver turns dark brown |

1. A method of coating a surface of a precious metal or a surface of a precious metal alloy, comprising the steps of coating the surface with a solution comprising a polysilazane of formula I, a solvent and a catalyst 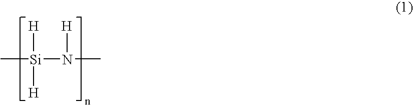
wherein n is such that the polysilazane has a number-average molecular weight of 150 to 150 000 g/mol, wherein, prior to the coating step, a sulfur-containing, silane-based primer is applied to the surface to be coated, for the purpose of promoting the adhesion.

2. The method as claimed in claim 1, wherein the sulfur-containing, silane-based primer has at least one silane having a sulfur-containing functional group.

3. The method as claimed in claim 1, wherein the sulfur-containing, silane-based primer comprises one or more silanes of the formula 2 to 4
HS—CH₂—CH₂—CH₂—SiR₃ (2)
R₃Si—CH₂—CH₂—CH₂—S—S—CH₂—CH₂—CH₂—SiR₃ (3)
R₃Si—CH₂—CH₂—CH₂—S—S—S—S—CH₂—CH₂—CH₂—SiR₃ (4)
where R is identical or different and is an alkyl radical or an alkoxy radical.

4. The method as claimed in claim 1, wherein the precious metal is a metal or an alloy of a metal whose standard potential ε₀ (in volts) in the electrochemical voltage series with respect to the standard hydrogen electrode (0 volts) has a value of >0.3 volt.

5. The method as claimed in claim 1, wherein the precious metal is silver or a silver alloy.

6. The method as claimed in claim 1, wherein the polysilazane solution contains 1% to 50% by weight of the polysilazane of the formula (I).

7. The method as claimed in claim 1, wherein the polysilazane solution contains 0.001 to 10%, of the catalyst, based on the weight of the polysilazane.

8. The method as claimed in claim 1, wherein the catalyst comprises at least one compound selected from the group consisting of: N-heterocyclic compounds, mono-, di-, and trialkylamines, organic acids, inorganic acids, metal carboxylates of the general formula (RCOO)ₙM of saturated and unsaturated, aliphatic or alicyclic carboxylic acids with R=C₁-C₂₂ and metal ions M with the charge n, acetylacetonate complexes of metal ions, metal powders having a particle size of 20 to 500 nm, peroxides, metal chlorides, and organometallic compounds.

9. The method as claimed in claim 1, wherein the solvent is an anhydrous organic solvent.

10. The method as claimed in claim 1, wherein a second polysilazane coat is applied to the first polysilazane coat.

11. The method as claimed in claim 10, wherein the solution used for applying the second polysilazane coat is the same as for the first polysilazane coat.

12. The method as claimed in claim 10, wherein the solution used to produce the second polysilazane coat is a solution comprising one or more substituted polysilazanes which instead of one or more hydrogen atoms on the silicon or nitrogen are substituted by one or two organic radicals.

13. A coating for a precious metal surface, produced by a method as claimed in claim 1.

14. The method as claimed in claim 3, wherein R is identical or different and is methyl, ethyl or propyl.

15. The method as claimed in claim 3, wherein R is identical or different and is methoxy, ethoxy or propoxy.

16. The method as claimed in claim 1, wherein the polysilazane solution contains 3% to 30% by weight of the polysilazane of the formula (I).

17. The method as claimed in claim 1, wherein the polysilazane solution contains 5% to 20% by weight of the polysilazane of the formula (I).

18. The method as claimed in claim 1, wherein the polysilazane solution contains 0.01% to 6% of the catalyst, based on the weight of the polysilazane.

19. The method as claimed in claim 1, wherein the polysilazane solution contains 0.1 to 3% of the catalyst, based on the weight of the polysilazane.

20. The method as claimed in claim 9, wherein the anhydrous organic solvent contains no reactive groups.

21. A precious metal comprising a coated surface, wherein the coated surface is coated in accordance with the method of claim 1.

22. A precious metal alloy comprising a coated surface, wherein the coated surface is coated in accordance with the method of claim 1.
